(19) United States
(12) Patent Application Publication
(10) Pub. No.: US 2026/0246819 A1
(43) Pub. Date: Aug. 20, 2026

(54) Rx MESSAGE HANDLING BETWEEN BSF AND PCF

(71) Applicant: Oracle International Corporation, Redwood City, CA (US)

(72) Inventor: Rajiv Krishan, Cary, NC (US)

(21) Appl. No.: 19/054,395

(22) Filed: Feb. 14, 2025

(51) Int. Cl. H04L 65/1069; H04L 41/0894; H04L 67/02; H04L 67/51

(52) U.S. Cl. CPC H04L 65/1069; H04L 67/02; H04L 67/51; H04L 41/0894

(57) ABSTRACT

Various embodiments of the present technology generally relate to systems and methods for performing Rx message handling between a binding support function (BSF) and a policy control function (PCF). In an embodiment, a PCF system may comprise one or more processors, and a memory having stored thereon instructions. The instructions, upon execution, may cause the one or more processors to receive, from a BSF, a first Rx session request including a cookie custom attribute value, look up an N7 session corresponding to the first Rx session request in a primary table using the cookie custom attribute value, and provide a response message to the BSF based on the N7 session.

### TECHNICAL FIELD

Various embodiments of the present technology generally relate to management of networks, such as fifth generation (5G) communications networks. More specifically, embodiments of the present technology relate to systems and methods for improved handling of Rx messages between a binding support function (BSF) and a policy control function (PCF).

### BACKGROUND

In some communication network architectures, such as those using third generation partnership project (3GPP) standards, service may be implemented by establishing a user communication session, such as a UE (User Equipment) session or a PDU (packet data unit or protocol data unit) session. To support a voice or data call, a number of network functions (NFs) within a 5G network may work together to manage aspects of the session.

When subscriber sessions are created, they may be associated with and managed by particular NFs. Other NFs may need to maintain databases or tables enabling them to look up and determine which NF is managing a corresponding session, so that relevant messages and service requests can be routed to the correct NF.

In a particular example, when a subscriber session is established, a session management function (SMF) may create an N7 session, including assigning a policy control function (PCF) to generate policy rules for the session to control quality of service (QoS) and charging. The PCF assigned to the session may register with a binding support function (BSF), and the BSF can create a binding record for the session in its database, which may identify the PCF associated with the subscriber. The binding record can ensure that an application function (AF) for a certain subscriber request received at the BSF can reach the relevant PCF having the session information for AF or Rx sessions associated with the subscriber. Rx interface messages enable the transport of application-level session information from an AF to a PCF or PCRF (Policy and Charging Rules Function), and an Rx session may be used to allocate and manage data resources for a PDU session. When a BSF receives an Rx session initiation request, the BSF may perform a lookup on its binding records to identify the PCF associated with the subscriber based on information provided in the Rx message. The BSF may then forward the Rx message to the appropriate PCF, once identified. The PCF may then need to perform another lookup operation to identify the appropriate N7 session, again based on the information provided in the Rx message. The type of information provided in an Rx message for the lookup operations can vary, and therefore the BSF and PCF may need multiple ways to perform the lookups based on the type of information received. This can require both the BSF and PCF to maintain multiple databases and lookup tables, resulting in a complex lookup operation at each component each time a new Rx session is initiated. Moreover, the lookup operations performed by the BSF and PCF may be highly duplicative, resulting in similar repetitive work being performed within the network.

While the functions of the BSF and PCF could be collocated, there are multiple disadvantages to this. Network operators may wish to have multiple PCF instances, to minimize latency and for resiliency and redundancy. Meanwhile, operators may wish to maintain a centralized BSF, and collocating the functionality of PCF and BSF may defeat the purpose of a centralized BSF. PCF may perform many functions that do not rely on Rx messaging or BSF, and therefore having a single centralized PCF and BSF to avoid duplicative lookup operations may not outweigh the latency and network risk associated with having a single centralized PCF and BSF. However, current 3GPP standards do not provide a mechanism to avoid the complex and duplicative lookup operations at distributed PCFs and BSFs. Accordingly, there exists a need for improved Rx message handling between BSFs and PCFs.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for performing Rx message handling between a BSF and a PCF. In an embodiment, a policy control function (PCF) system may comprise one or more processors, and a memory having stored thereon instructions. The instructions, upon execution, may cause the one or more processors to receive, from a binding support function (BSF), a first Rx session request including a cookie custom attribute value, look up an N7 session corresponding to the first Rx session request in a primary table using the cookie custom attribute value, and provide a response message to the BSF based on the N7 session.

In some embodiments, the PCF system may receive an N7 session creation request, generate the cookie custom attribute value in response to the N7 session creation request, and send a binding request to the BSF in response to the N7 session creation request, the binding request including the cookie custom attribute value. The PCF system may receive the N7 session creation request from a session management function (SMF), and generate the cookie custom attribute value as a session management policy identifier (smPolicyId) value. In some examples, the PCF system may receive a second Rx session request not including the cookie custom attribute value, look up a primary key value from a secondary table using identifying information from the second Rx session request as a secondary key, and look up a second N7 session corresponding to the second Rx session request in the primary table using the primary key value. The PCF system may maintain a plurality of secondary tables for looking up the primary key value, the plurality of secondary tables using different potential identifying information elements from Rx session requests as secondary keys, and determine which secondary table from the plurality of secondary tables to use based on which information is included in the second Rx session request. In some embodiments, the PCF system may determine whether the BSF supports a cookie custom feature based on an NF profile obtained from a network repository function (NRF). The PCF system may send the binding request including the cookie custom attribute value to the BSF when the BSF supports the cookie custom feature, and not send the cookie custom attribute value with the binding request when the BSF does not support the cookie custom feature. In some embodiments, the PCF system may determine whether every BSF instance in a network including the PCF supports the cookie custom feature based on NF profiles obtained from the NRF. The PCF system may maintain the plurality of secondary tables when not every BSF instance in the network supports the cookie custom feature, and not maintain the plurality of secondary tables when every BSF instance in the network supports the cookie custom feature. In some examples, the first Rx session request includes an initial authorization authentication request (AAR-I) message, and the response message includes an application authentication answer (AAA) message.

In an alternative embodiment, a method may comprise operating a policy control function (PCF) of a mobile network, including receiving, from a binding support function (BSF), a first Rx session request including a cookie custom attribute value, looking up an N7 session corresponding to the first Rx session request in a primary table using the cookie custom attribute value, and providing a response message to the BSF based on the N7 session.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of a system configured to implement Rx message handling between BSF and PCF, in accordance with certain embodiments of the present disclosure;

FIG. 2 is a diagram of a system configured to implement Rx message handling between BSF and PCF, in accordance with certain embodiments of the present disclosure;

FIG. 3 depicts a set of caches for implementing Rx message handling between BSF and PCF, in accordance with certain embodiments of the present disclosure;

FIG. 4 depicts a flow diagram of an example method to perform Rx message handling between BSF and PCF, in accordance with certain embodiments of the present disclosure;

FIG. 5 depicts a flowchart of an example method to perform Rx message handling between BSF and PCF, in accordance with certain embodiments of the present disclosure;

FIG. 6 depicts a flowchart of an example method to perform Rx message handling between BSF and PCF, in accordance with certain embodiments of the present disclosure; and

FIG. 7 is a diagram of a system configured to implement Rx message handling between BSF and PCF, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

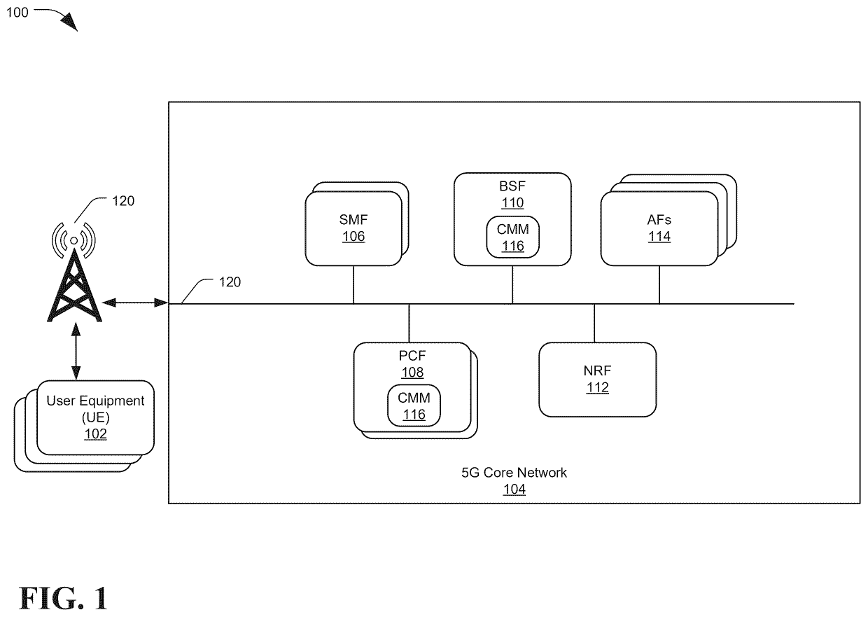

FIG. 1 is a diagram of a system 100 configured to implement Rx message handling between BSF and PCF, in accordance with certain embodiments of the present disclosure. The example system 100 may include a mobile network implementing 3GPP (3rd Generation Partnership Project) communication standards, although the present disclosure may apply to other communication networks. In particular, the mobile network may include components and elements to implement a cellular network, such as a 5G Core (5GC or 5GS) network 104. The system 100 may include one or more user equipment (UE) 102 connected to 5G network 104 via network connectivity components 120.

Each or any of UE 102, 5G network 104 and its components, and network 120 may be implemented via computers, servers, hardware and software modules, or other system components. The components of 5G network 104, or the physical devices implementing them, may be co-located, remotely distributed, or any combination thereof. The elements of system 100 may include components hosted or situated in the cloud, implemented as software modules potentially distributed across one or more server devices or other physical components, or otherwise implemented.

UE 102 may be a device, system, or module that may utilize the resources of the 5G network 104, such as to establish communications with another UE. Communication sessions may include, but are not limited to, IMS calls (Internet Protocol Multimedia subsystem), other cell phone calls, internet or other data connections, or any and all other types of communications sessions over 5G networks. UE 102 may include devices such as cell phones, tablets, modems, vehicles, desktop or laptop computers, televisions or set-top boxes, smart home devices, voice over IP (VoIP) devices, internet of things (IoT) devices, or any and all other systems that may utilize a cellular network.

Network connectivity components 120 may provide communication paths between UE 102 and 5G network 104. Network connectivity components 120 may comprise components that enable communication over communication links, such as network cards, ports, radio frequency (RF) modules, telecommunications channels, cell towers, switches, routers, processing circuitry and software, or other communication components. Network connectivity components 120 may include metallic, wireless, cellular, or optical links, using various communication formats and protocols. In some examples, network connectivity components 120 may simply be referred to as a “network” by which systems or modules are connected or communicate.

The 5G network 104 may comprise a mobile communications network that provides services to UEs 102 through the network connectivity components 120. 5G network 104 may include a plurality of components, modules, or network functions (NFs) configured to provide mobile communication services via the corresponding 5G Core communications protocols. Some components of 5G network 104 may be configured to communicate and operate with other networks, such as 4G networks, networks controlled by other network operators, or other network environments. Although referred to as a 5G core network 104, the network 104 may include components associated with 5G service, 4G service, or a combination thereof. 5G core network 104 may include a session management function (SMF) 106, one or more policy control functions (PCFs) 108, a binding support function (BSF) 110, a network or NF repository function (NRF) 112, a plurality of application functions (AFs) 114, any of which may be referred to as types of NFs, in some embodiments.

5G network 104 may include an SMF 106 configured to handle subscriber session establishment, modification, and release. When a UE 102 connects to the 5G network 104, an SMF 106 may initiate the session creation, such as by selecting a PCF 108 to assign to the session by sending an N7 session creation request. SMF 106 may use the N7 interface to retrieve session management policy information for a UE's PDU session. SMF 106 may include various functionality relating to subscriber sessions, e.g., session establishment, modification, and release.

PCF 108 may be assigned to an N7 session created when a UE 102 registers with the 5G network 104 or when a UE attempts establishment of a PDU session, respectively. PCF 108 may generate policy rules for the session to control quality of service and charging for the session, and may register the session with BSF 110. PCF 108 may also register with NRF 112, and may provide metadata or other information to NRF 112 identifying capabilities or configuration settings for PCF 108. PCF 108 may operate as an individual unit, or as part of a PCF set, where an N7 session may be managed by any available or most convenient PCF from a corresponding PCF set.

BSF 110 may maintain a list, database, or other data structure of binding records describing which PCF 108 is assigned to a subscriber N7 session, or which PCF 108 is assigned to a subscriber registration related association. BSF 110 may provide the binding support management service (Nbsf_Management service), allowing BSF 110 to provide 5G session binding functionality, which can ensure that an AF 114 request for a certain session can reach the relevant PCF 108 having the session information. BSF 110 may obtain information about a PCF 108 and its capabilities from NRF 112, from messages received from PCF 108, or a combination thereof. BSF 110 may create a binding record when PCF 108 registers an N7 session with BSF 110. AF 114 seeking to establish an Rx session may send an Rx session initiation request message (sometimes referred to as an initial authorization authentication request, or AAR-I message) to BSF 110 for forwarding to the appropriate PCF 108. BSF 110 may use information included in the AAR-I message to perform a lookup in its databases and identify the relevant PCF 108, to which it may forward the AAR-I message. BSF 110 may also register with NRF 112, and may provide metadata or other information to NRF 112 identifying capabilities or configuration settings for BSF 110.

NRF 112 may be a monitoring element which includes and maintains a repository of NF profiles for available NF instances (including, e.g., SMF 106, PCF 108, BSF 110, and AFs 114). The NF profiles may identify what services or resources each NF provides, and potentially metadata provided by the NF, which may specify vendor-specific features supported by the NF but not included in standard 3GPP specifications. For example, NFs may register to provide registration information and metadata regarding the NF to NRF 112 for storing in the repository. Once an NF is registered with NRF 112, the NRF may provide information regarding the NF in response to discovery requests. For example, an NF may send a discovery request to NRF 112 including search criteria, and the NRF may issue a discovery response providing identifying information and metadata for NFs in the repository matching the search criteria. Consumer NFs can subscribe to receive information about producer NF instances that have registered with NRF 112. In an example embodiment, PCF 108 may query NRF 112 for NF profiles for all BSF 110 instances on the network 104, to determine what functionality they support. PCF 108 may further subscribe to NRF 112 for updates regarding BSF 110 instances, including any changes to existing BSF instances or the addition or removal of any BSF instances from the 5G network 104. In this manner, PCF 108 may remain appraised with details on the functionality of BSFs 110.

AFs 114 may be configured to manage and provide application services to subscribers and UEs 102. When a subscriber initiates an IMS voice call, for example, an AF 114 may send an Rx request (e.g., including an AAR-I message) to BSF 110, directing the BSF to route the message to the appropriate PCF 108 assigned to the subscriber or SUPI (subscription permanent identifier, or subscriber ID) for the voice call. The AAR-I message may include details about the voice call or subscriber to enable the BSF 110 to look up the appropriate PCF 108. However, what type of details are included in the AAR-I message may not be consistent or predictable, and therefore BSF 110 may maintain multiple lookup tables for binding information to locate the appropriate PCF 108, such as a different lookup table for each potential set of information provided by an AAR-I message. Once the appropriate PCF 108 is identified, BSF 110 may forward the AAR-I message, and then receive a response (e.g., such as an application authentication answer, or AAA message) from the PCF, which the BSF may forward back to the AF 114 that issued the AAR-I. In this manner, AF 114 may manage properties of communication sessions for various resources via PCF 108.

As noted above, BSF 110 may maintain a plurality of lookup tables to determine which PCF 108 corresponds to an Rx request, such as a first set of tables to look up a binding record ID based on a variety of potential information elements provided in the Rx request, and then another lookup table to retrieve the binding record information based on the binding record ID. Once the correct PCF 108 has been identified, BSF 110 may forward the Rx request to the appropriate PCF 108. When PCF 108 receives the Rx request, it may need to perform a similar lookup to that performed by BSF 110 in order to identify the appropriate N7 session corresponding to the Rx request. That is, PCF 108 may maintain multiple tables corresponding to the various potential types of identifying information included in the Rx request, in order to look up an N7 session identifier, and then another table to look up the N7 session context information based on the session identifier. These similar DB lookups may result in duplicative operations being performed for every Rx request, which may be wasteful of compute resources. In addition to the processing inefficiencies for the lookup operations, both BSF 110 and PCF 108 may need to maintain multiple indexed tables or “helper” tables for secondary keys to cover the potential identifying information that may be included in the Rx requests. The secondary keys may allow for the lookup of primary keys, such as record IDs for binding records or N7 session records. The primary keys may be used for direct lookup of the full records in a context or main lookup table during Rx flow processing. Maintaining the multiple databases or lookup tables may require additional database (DB) resources.

In order to avoid the DB and compute resources required for Rx processing lookups at both BSF 110 and PCF 108, a system employing PCF 108 “cookies”, or special custom attributes, it proposed. The proposed approach may involve the addition of a cookie management module (CMM) 116 at PCF 108, BSF 110, or both. The CMM 116 may perform operations and procedures to improve efficiency in Rx flow processing by reducing the compute and DB resources required at PCF 108.

When PCF 108 receives an N7 session creation request from SMF 106, the PCF 108 may assign a session management policy ID value (e.g., smPolicyId) to the created session, and return it SMF 106. When PCF 108 issues a binding record creation request to BSF 110, the PCF (e.g., via CMM 116) may include a “cookie” custom attribute to add to the pcfBinding object at the BSF 110. The cookie may include a value, such as the smPolicyId, which the PCF 108 can use to directly look up the corresponding N7 session, without the use of secondary keys or helper tables. For example, the custom attribute may take the form:
“vendorspecific-000111”: {
   “cookie”: {smPolicyId=<smPolicyId>}
}

BSF 110 (e.g., via CMM 116), if configured to recognize the custom vendor-specific attribute, may store the cookie information along with the binding record. Upon receiving an Rx AAR-I message from AF 114, BSF 110 may perform a binding lookup operation to find details on which PCF 108 to route the Rx request to, based on identifying information included in the Rx message, as previously described. When the PCF 108 details are located, BSF 110 may retrieve the stored cookie value, and add a custom “BsfPcfCookie” attribute value pair (AVP) with the cookie value to the Rx AAR-I message, and forward it to PCF 108.

PCF 108 may receive the AAR-I request and extract the BsfPcfCookie AVP value. Based on the BsfPcfCookie, which may contain, e.g., an smPolicyId value for a particular N7 session, PCF 108 may perform N7-Rx mapping to map the Rx request to the appropriate N7 session. PCF 108 may use the smPolicyId cookie value to look up the correct N7 session directly, without performing complex multi-table or DB lookup operations. This may save compute work at PCF 108 and reduce processing latency for subscriber calls.

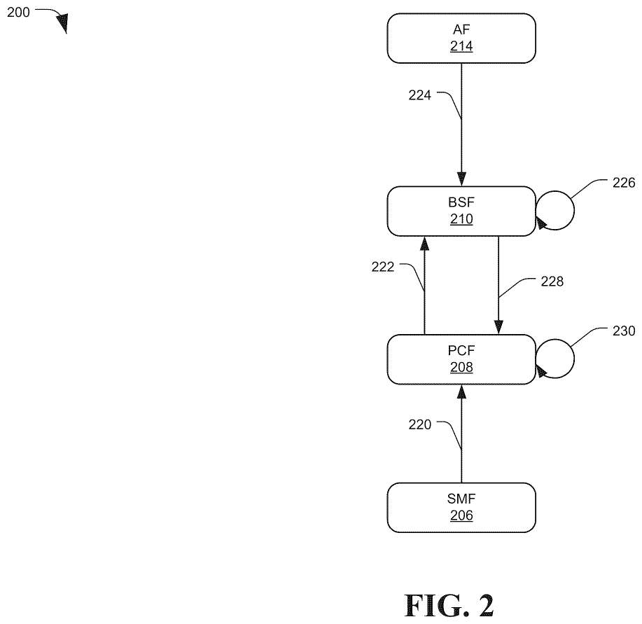

Further, PCF 108 may monitor support of BSF 110 instances in network 104 for the BsfPcfCookie functionality, for example by querying NRF 112 for NfProfiles for BSFs, and subscribing to NRF 112 to receive updates on changes to BSFs in the network 104. For example, BSF 110 may publish “BsfPcfCookie” as a custom feature in “supportedVendorSpecificFeatures” of its profile at NRF 112. Based on whether a BSF 110 instance supports the cookie feature, PCF 108 may choose whether or not to include a cookie when creating a binding record. Alternately, PCF 108 may include cookies in all binding record requests, and BSFs 110 that do not support the feature may simply ignore the cookie and process the binding request under standard protocols. When all BSF 110 instances in the network 104 support the cookie feature, PCF 108 may know it will receive a BsfPcfCookie AVP with each AAR-I request. Accordingly, PCF 108 may choose to stop maintaining secondary key tables for complex lookup operations on Rx requests. This may further improve processing latency, and may reduce storage requirements at PCF 108. A diagram for session establishment and lookup is further described in regard to FIG. 2.

FIG. 2 is a diagram of a system 200 configured to implement Rx message handling between BSF and PCF, in accordance with certain embodiments of the present disclosure. In particular, system 200 depicts an example set of NFs within a mobile communications network use to establish N7 and Rx sessions for a subscriber. The NFs may include SMF 206, PCF 208, BSF 210, and AF 214. The components may correspond to SMF 106, PCF 108, BSF 110, and AF 114 as described in regard to FIG. 1.

When a subscriber device makes a PDU session establishment request, SMF 206 may set up an N7 session with PCF 208, at 220. PCF 208 may respond with a location header having a resource of smPolicyId. Further, PCF 208 may create a session binding record at BSF 210, via 222, which may include details such as mapping a user equipment (UE) IP address to the selected PCF 208.

When the subscriber initiates a service request, such as by starting a voice call, AF 214 may issue an Rx interface AAR-I request to BSF 210, via 224. The Rx request may have various types or combinations of identifying information which can be used to identify a PCF 208 assigned to the subscriber or UE initiating the call. BSF 210 may maintain various helper or secondary tables, each corresponding to different sets of potential identifying information from the Rx request, in order to identify the correct PCF 208 for the call. BSF 210 may perform the complex lookup operation at 226, and then forward the Rx AAR-I request to the identified PCF 208, via 228.

PCF 208 may receive the Rx AAR-I request, and may need to perform similar complex lookup operations, based on the identifying information from the AAR-I request, to identify the appropriate N7 session, and perform Rx-N7 mapping, at 230. As previously described, this process may require maintaining multiple helper tables for secondary keys in order to look up a primary key, and then using the primary key to retrieve the N7 session details.

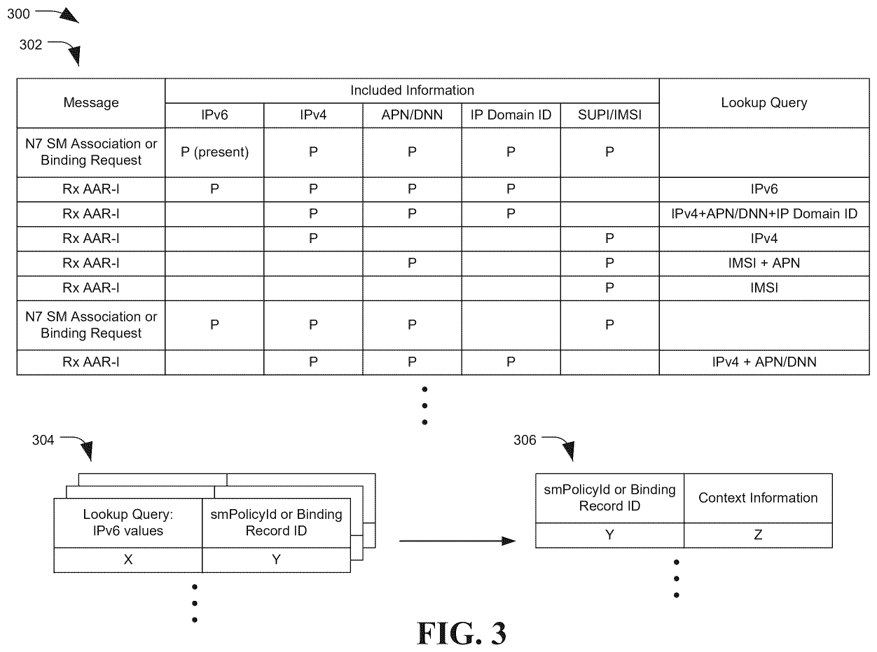

An improvement may be achieved via the usage of the cookie feature. When an N7 session is created at PCF 208 and the smPolicyId is generated, PCF 208 may include the smPolicyId (or other primary key value) as a “cookie” in a custom attribute included with the binding request to BSF 210, at 222. BSF 210 may then store the cookie value along with the binding record. When BSF 210 receives the Rx AAR-I request, at 224, BSF 210 may lookup (via 226) the appropriate PCF 208, and retrieve the stored cookie value. BSF 210 may include the cookie as a custom “BsfPcfCookie” AVP with the AAR-I request when forwarding it to PCF 208, via 228. PCF 208 may extract the BsfPcfCookie value, and use it to directly look up the corresponding N7 session for the Rx session, at 230, without the need for secondary keys or helper tables. Examples of the caches, tables, or DBs utilized for the binding or N7 session lookup operations are described in regard to FIG. 3.

FIG. 3 depicts a set of caches 300 for implementing Rx message handling between BSF and PCF, in accordance with certain embodiments of the present disclosure. In particular, FIG. 3 depicts a set of tables or databases relevant to session or binding creation and lookup in a 5G network. Table 302 may represent potential data included in N7 SM association (e.g., from SMF to PCF) or binding requests (e.g., from PCF to BSF), and in Rx AAR-I requests (e.g., from AF to BSF), and what data may be used for lookup queries depending on the data in the N7 or binding requests and AAR-I requests. Table 304 may represent an example set of helper or secondary tables, via which a secondary key may be used to look up a primary key. The secondary keys for each table 304 may depend on the “lookup query” criteria from table 302 based on the information included in the Rx AAR-I request. Table 306 may include a primary or context table via which a primary key may be used to retrieve context information for an N7 session or binding record.

Table 302 may include a “message” column, indicating a type of message via which various information was received. The “Included Information” columns may indicate what types of information may be received in the corresponding message. In the provided example, the message types include N7 SM (session management) association requests or binding requests, and Rx AAR-I requests.

N7 SM association requests may be sent from an SMF to a PCF when a subscriber makes a network access request, and may be used to assign a PCF to a subscriber and establish an N7 session. The first example N7 SM association or Binding Request entry may include all the potential data fields, including an IPv6 value, IPv4 value, access point name (APN)/data network name (DNN) value, IP domain ID value, and a subscription permanent identifier (SUPI) or international mobile subscriber identity (IMSI) value. The PCF or BSF may store these received values as part of the N7 session record or binding record. The PCF may create and assign an N7 session identifier to the newly created N7 session, and similarly the BSF may create and assign a binding record identifier.

Rx AAR-I messages may be sent from an application function (AF) to a BSF, for forwarding to an appropriate PCF managing the subscriber for a new voice call session, for example. The Rx AAR-I may include various information elements from the “included information” columns, which the BSF and PCF may then use to identify the appropriate binding record or N7 session, respectively. For example, the first listed Rx AAR-I message format in table 302 may include IPv6, IPv4, APN/DNN value, and IP domain ID, but not SUPI or IMSI value.

The PCF or BSF may not know which identifying values may be received as part of an Rx AAR-I request in order to look up the correct N7 session or binding record. Accordingly, the Lookup Query column of table 302 defines which included information from the Rx AAR-I message may be used as a key to look up a N7 session or binding record, where the values may be different depending on which information is available from the Rx AAR-I message. For example, if the Rx AAR-I message includes an IPv6 value, that information may be used as the key value for a record lookup. However, in other examples, a combination of multiple information elements may be used instead. Similarly, which information may be used as a lookup query key may change based on what information was included in the N7 SM Association request or Binding Request. For example, if the Rx AAR-I message includes an IPv4 value, APN/DNN value, and IP domain ID, a combination of all three items may be used as a lookup key to find an N7 session or binding record that includes all three of those elements. However, if the N7 session or binding record doesn't include the IP domain ID value (as in the second N7 SM association or binding request entry example of table 302), only the IPv4 and APN/DNN values may be used to look up the appropriate record. In some embodiments, the PCF or BSF may not know what data elements are available in the N7 session or binding record when the Rx AAR-I message is received, in order to use the “correct” combination of search elements. According, the PCF or BSF may attempt searching a first combination of data elements, and if no hits are found, attempt a next combination, etc. The PCF or BSF may also attempt to search with more parameters first (e.g., IPv4+APN/DNN+IP Domain ID before searching IPv4+APN/DNN, which may be searched before just IPv4), as certain data elements may be reused multiple times across a network and using more lookup parameters may ensure a specific correct record is located.

Due to the multiple potential lookup query information elements, the PCF and BSF may maintain multiple helper or secondary key tables 304. The PCF and BSF may maintain a different helper table 304 for each potential Lookup Query combination, potentially resulting in these network components needing to maintain many helper tables 304. For each helper table 304, the lookup query combination may be the key, and each value may map to a corresponding N7 session identifier (e.g., smPolicyId) or binding record identifier.

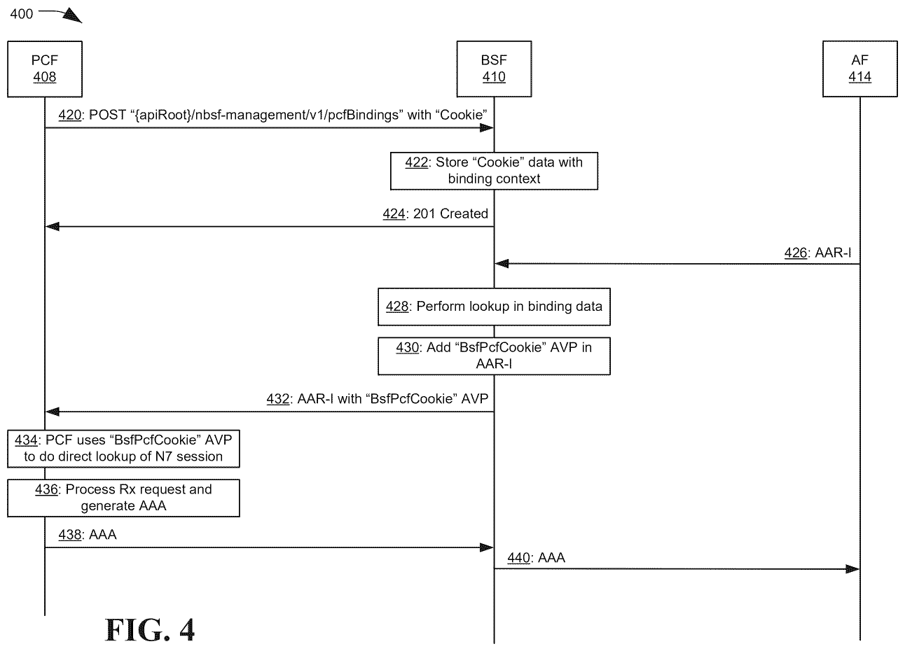

The N7 session identifier or binding record ID retrieved from the helper table 304 may be used as a primary key to access the primary or context table 306. The primary table 306 may have each N7 identifier or binding record identifier map to the corresponding context information for that record, with the relevant details for the N7 session or binding record. The BSF may use the binding record context information to identify the correct PCF for the Rx AAR-I message and forward the request. In the proposed improvement, the BSF may also retrieve a stored BsfPcfCookie value and add it to the Rx AAR-I message before forwarding it to the appropriate PCF. A PCF may use the context information from primary table 306 to link the appropriate N7 session to the Rx session. The PCF can either retrieve the primary key for table 306 from the information in the Rx AAR-I message via helper tables 304, or it may receive the primary key information directly in the form of the BsfPcfCookie AVP from the BSF, and therefore bypass the lookup process via helper tables 304. Further, if a PCF determines that all BSFs in the network support the “cookie” functionality, it may stop maintaining helper tables 304 altogether, thereby saving on both processing and storage resources for the PCF. A process for utilizing the proposed cookie feature is described in regard to FIG. 4.

FIG. 4 depicts a flow diagram 400 of an example method to perform Rx message handling between BSF and PCF, in accordance with certain embodiments of the present disclosure. In particular, the diagram 400 may depict a process flow within a 5G communication network by which a PCF may provide a “cookie” custom attribute along with a binding request in order to bypass duplicative lookup operations at the PCF in response to Rx session requests. Diagram 400 may depict an example message and processing flow between a PCF 408, a BSF 410, and an AF 414. The components in diagram 400 may correspond to elements described in regard to FIGS. 1 and 2.

At 420, PCF 408 may send a POST message to BSF 410, which may include a binding record creation request along with a “cookie” custom attribute. The message may be sent in response to the establishment of an N7 session between the PCF 408 and an SMF (not shown). The included “cookie” may include a value which the PCF 408 may use to directly look up the corresponding N7 session, without the use of secondary keys or helper tables.

At 422, BSF 410 may create the binding record and store the “cookie” data with the binding context information. BSF 410 may then issue a “201 Created” response message to PCF 408, at 424, which may indicate the requested binding record was created.

At 426, AF 414 may issue an Rx message to BSF 410 including an AAR-I request. The AAR-I request may include various potential information elements that may be used to identify a subscriber for a new session, and to identify a PCF 408 assigned to manage the subscriber. Based on the provided information, BSF 410 may perform a lookup operation on its binding record to locate binding data for the appropriate PCF 408, at 428. The lookup operation may include utilizing one or more secondary or helper tables to retrieve a primary key, and using the primary key on a primary or context table to retrieve the appropriate binding record. The binding record context information may include the stored “cookie” value received from PCF 408 and stored at 422. BSF 410 may add a “BsfPcfCookie” attribute value pair (AVP), and add it to the AAR-I message, at 430. The AAR-I message, along with the BsfPcfCookie, may be forwarded from BSF 410 to PCF 408, at 432.

PCF 408 may receive the AAR-I message and included BsfPcfCookie, and utilize the BsfPcfCookie value to perform a direct lookup on a context table to retrieve the information for the appropriate N7 session to associate with the AAR-I message, at 434. This direct lookup via the BsfPcfCookie may allow the PCF 408 to avoid the duplicative lookup operations on secondary or helper tables, and thereby reduce a processing load and latency at PCF 408.

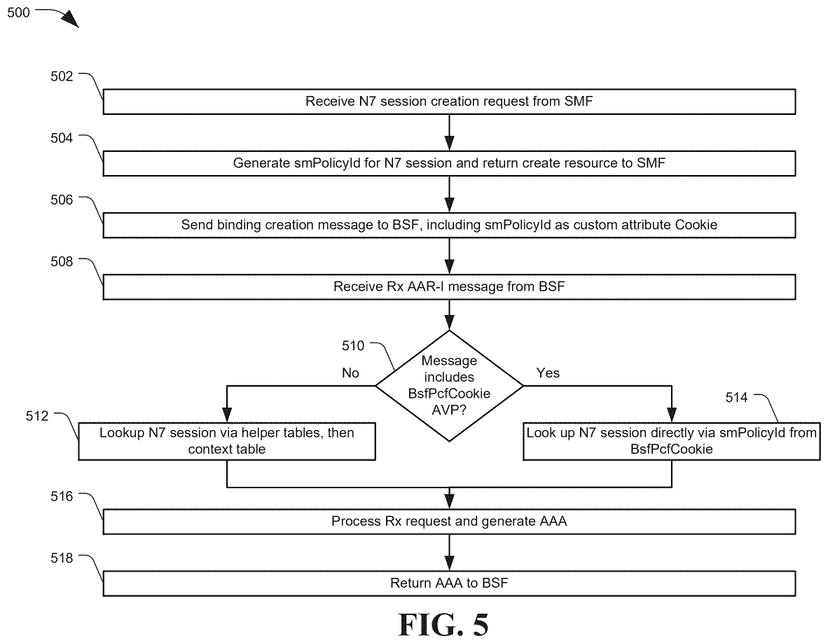

PCF 408 may process the Rx request and generate an AAA response message, at 436, and send the response to BSF 410, at 438. BSF 410 may forward the AAA message to AF 414, at 440. An example method for Rx message handling is described in regard to FIG. 5.

FIG. 5 depicts a flowchart 500 of an example method to perform Rx message handling between BSF and PCF, in accordance with certain embodiments of the present disclosure. In particular, flowchart 500 depicts an example process by which a PCF may utilize a “cookie” custom attribute when registering a binding record with a BSF, and then use that cookie to perform direct lookup of N7 sessions without the need for more complex lookup operations. The method of flowchart 500 may be executed by a PCF, such as PCFs 108, 208, and 408 of FIGS. 1, 2, and 4, respectively.

The method may include receiving an N7 session creation request from a session management function (SMF), at 502. The PCF may generate a smPolicyId value for the N7 session, and return a create resource response to the SMF with the smPolicyId value, at 504. The N7 session creation request or session management (SM) association request may include information on the N7 session that may be saved at the PCF as context information. The context information may be accessed at the PCF via a database or table using a primary key, such as a session identifier value (e.g., smPolicyId), as a lookup key. In some embodiments, the PCF may update secondary or helper tables, providing a way to access the primary key via various possible informational elements as secondary keys.

At 506, the method may include sending a binding creation request or message to a binding support function (BSF), and including the smPolicyId as a custom attribute “cookie” value with the binding request. The binding request may direct the BSF to create a binding record that associates the issuing PCF with the corresponding N7 session.

At 508, the method may include receiving an Rx AAR-I message from a BSF. The AAR-I message may be to request resources for an Rx session, such as a call request, from the network, and may need to be directed to the appropriate PCF assigned to the corresponding subscriber. Accordingly, the BSF may have had to perform a series of lookup operations based on information included in the AAR-I request in order to identify the PCF as the target of the message.

At 510, the method may include determining whether the Rx AAR-I message includes a BsfPcfCookie attribute value pair (AVP). If not, the method may including performing lookup operations at the PCF based on information included in the AAR-I request to identify a corresponding N7 session. The lookup operations may include determining what information was included in the AAR-I request, accessing one or more secondary tables at the PCF based on that information to retrieve a primary key, and then utilizing the primary key on a primary table to retrieve context information for the correct N7 session.

However, if a BsfPcfCookie AVP was included along with the AAR-I request, at 510, the method may include looking up the N7 context information on the primary table directly, such as by using the smPolicyId value from the BsfPcfCookie as a primary key value, at 514. The cookie may therefore provide significant savings on processing and latency times for handling the AAR-I request at the PCF.

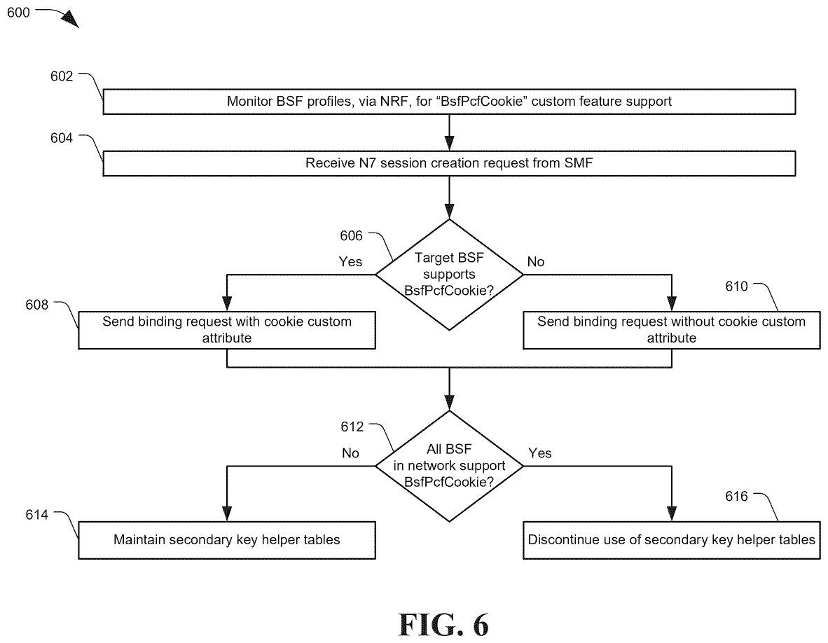

After retrieving the correct N7 session context information, at 512 or 514, the method may include processing the Rx AAR-I request and generating an application authentication answer (AAA) response message, at 516. The AAA message may be sent to BSF, at 518, for forwarding to an application function (AF) that issued the Rx AAR-I message. A method for monitoring cookie custom attribute support at BSFs in a network is discussed in regard to FIG. 6.

FIG. 6 depicts a flowchart 600 of an example method to perform Rx message handling between BSF and PCF, in accordance with certain embodiments of the present disclosure. In particular, flowchart 600 shows a process for monitoring support for cookie custom attributes at BSFs within a network, and using that information to determine when to include cookies with binding record requests and how to manage secondary or helper tables at a PCF. The method of flowchart 600 may be executed by a PCF, such as PCFs 108, 208, and 408 of FIGS. 1, 2, and 4, respectively.

At 602, the method may include monitoring BSF profiles, via a network repository function (NRF), for “BsfPcfCookie” custom feature support. A PCF may request NF profiles for BSFs within a network from an NRF, and may further subscribe to the NRF for updates to BSFs, such as changes to NF profiles (and corresponding changes to feature support), or when BSFs are newly registered or deregistered from the network. A PCF may store the BSF details, to know which BSFs support the custom feature and which do not.

At 604, the method may include receiving an N7 session creation request from an SMF, including generating an smPolicyId value for the N7 session and returning it to the SMF, storing context details for the N7 session, and updating lookup tables.

Creation of an N7 session may also trigger the PCF to create a binding record with a BSF. Accordingly, at 606, the method may include determining whether the target BSF supports the BsfPcfCookie feature. If yes, the method may include sending the binding request from the PCF to the BSF along with a custom cookie attribute, such as the value for the smPolicyId for the newly created N7 session, at 608. However, if the BsfPcfCookie feature is not supported by the target BSF, the method may include sending a binding request without the cookie custom attribute, at 610. In some embodiments, the PCF may send the cookie value with all binding requests, regardless of whether the target BSF supports the feature. If the target BSF does not support the feature and receives a binding request with the cookie value, the BSF may simply ignore the cookie, and therefore the end result may be the same as not sending the cookie without the extra step of looking up feature support first at the PCF.

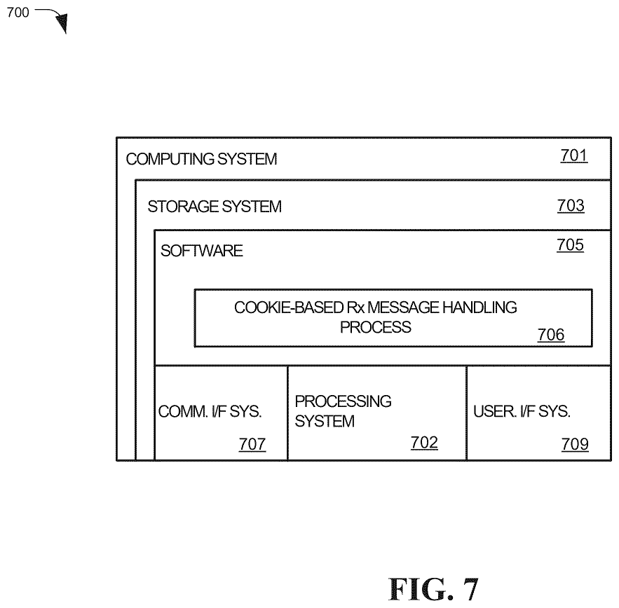

At 612, the method may include determining whether all BSF instances in the network support the BsfPcfCookie feature. If not, the method may include maintaining secondary key helper tables at the PCF, at 614. The PCF may need the helper tables to look up a correct N7 session for any AAR-I requests received from any BSF that does not support the cookie feature. However, if all BSFs do support the cookie feature, at 612, the method may include discontinuing use and maintaining the secondary key helper tables, at 616. When all BSF instances within a network support the cookie feature, the PCF may rely on receiving a BsfPcfCookie with each AAR-I request, and therefore may have no need for the helper tables. Eliminating the helper tables may reduce storage and processing requirements for a PCF, thereby improving the network performance. A computing system configured to perform the operations and methods described herein is provided in regard to FIG. 7.

FIG. 7 illustrates an apparatus 700 including a computing system 701 that is representative of any system or collection of systems in which the various processes, systems, programs, services, and scenarios disclosed herein may be implemented. Examples of computing system 701 include, but are not limited to, desktop computers, laptop computers, server computers, routers, web servers, cloud computing platforms, and data center equipment, as well as any other type of physical or virtual server machine, physical or virtual router, container, and any variation or combination thereof.

Computing system 701 may be implemented as a single apparatus, system, or device or may be implemented in a distributed manner as multiple apparatuses, systems, or devices. Computing system 701 may include, but is not limited to, processing system 702, storage system 703, software 705, communication interface system 707, and user interface system 709. Processing system 702 may be operatively coupled with storage system 703, communication interface system 707, and user interface system 709.

Processing system 702 may load and execute software 705 from storage system 703. Software 705 may include and implement cookie-based Rx message handling process 706, which may be representative of any of the operations for generating a cookie for use in looking up a session record, including the cookie along with a message between PCF and BSF or vice versa, storing the cookie value along with binding records or context information, utilizing a cookie to look up a session record, and determining how to handle secondary or helper lookup tables based on support for the cookie feature in NFs within the network, as discussed with respect to the preceding figures. When executed by processing system 702, software 705 may direct processing system 702 to operate as described herein for at least the various processes, operational scenarios, and sequences discussed in the foregoing implementations. Computing system 701 may optionally include additional devices, features, or functionality not discussed for purposes of brevity.

In some embodiments, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 may include general purpose central processing units, graphical processing units, application specific processors, and logic devices, as well as any other type of processing device, combinations, or variations thereof.

Storage system 703 may comprise any memory device or computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including cookie-based Rx message handling process 706 among other functions) may be implemented in program instructions that may, when executed by processing system 702, direct processing system 702 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system as described herein. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable storage medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A policy control function (PCF) system, comprising:
one or more processors; and
a memory having stored thereon instructions that, upon execution by the one or more processors, cause the one or more processors to:
receive, from a binding support function (BSF), a first Rx session request including a cookie custom attribute value;
look up an N7 session corresponding to the first Rx session request in a primary table using the cookie custom attribute value; and
provide a response message to the BSF based on the N7 session.

2. The PCF system of claim 1, wherein the instructions comprise further instructions that, upon execution by the one or more processors, cause the one or more processors to:
receive an N7 session creation request;
generate the cookie custom attribute value in response to the N7 session creation request; and
send a binding request to the BSF in response to the N7 session creation request, the binding request including the cookie custom attribute value.

3. The PCF system of claim 2, wherein the instructions comprise further instructions that, upon execution by the one or more processors, cause the one or more processors to:
receive the N7 session creation request from a session management function (SMF); and
generate the cookie custom attribute value as a session management policy identifier (smPolicyId) value.

4. The PCF system of claim 3, wherein the instructions comprise further instructions that, upon execution by the one or more processors, cause the one or more processors to:
receive a second Rx session request not including the cookie custom attribute value;
look up a primary key value from a secondary table using identifying information from the second Rx session request as a secondary key; and
look up a second N7 session corresponding to the second Rx session request in the primary table using the primary key value.

5. The PCF system of claim 4, wherein the instructions comprise further instructions that, upon execution by the one or more processors, cause the one or more processors to:
maintain a plurality of secondary tables for looking up the primary key value, the plurality of secondary tables using different potential identifying information elements from Rx session requests as secondary keys; and
determine which secondary table from the plurality of secondary tables to use based on which information is included in the second Rx session request.

6. The PCF system of claim 5, wherein the instructions comprise further instructions that, upon execution by the one or more processors, cause the one or more processors to:
determine whether the BSF supports a cookie custom feature based on an NF profile obtained from a network repository function (NRF).

7. The PCF system of claim 6, wherein the instructions comprise further instructions that, upon execution by the one or more processors, cause the one or more processors to:
send the binding request including the cookie custom attribute value to the BSF when the BSF supports the cookie custom feature; and
do not send the cookie custom attribute value with the binding request when the BSF does not support the cookie custom feature.

8. The PCF system of claim 7, wherein the instructions comprise further instructions that, upon execution by the one or more processors, cause the one or more processors to:
determine whether every BSF instance in a network including the PCF supports the cookie custom feature based on NF profiles obtained from the NRF.

9. The PCF system of claim 8, wherein the instructions comprise further instructions that, upon execution by the one or more processors, cause the one or more processors to:
maintain the plurality of secondary tables when not every BSF instance in the network supports the cookie custom feature; and
do not maintain the plurality of secondary tables when every BSF instance in the network supports the cookie custom feature.

10. The PCF system of claim 9, wherein:
the first Rx session request includes an initial authorization authentication request (AAR-I) message; and
the response message includes an application authentication answer (AAA) message.

11. A method comprising:
operating a policy control function (PCF) of a mobile network, including:
receiving, from a binding support function (BSF), a first Rx session request including a cookie custom attribute value;
looking up an N7 session corresponding to the first Rx session request in a primary table using the cookie custom attribute value; and
providing a response message to the BSF based on the N7 session.

12. The method of claim 11, further comprising:
receiving an N7 session creation request;
generating the cookie custom attribute value in response to the N7 session creation request; and
sending a binding request to the BSF in response to the N7 session creation request, the binding request including the cookie custom attribute value.

13. The method of claim 12, further comprising:
receiving the N7 session creation request from a session management function (SMF); and
generating the cookie custom attribute value as a session management policy identifier (smPolicyId) value.

14. The method of claim 12, further comprising:
determining whether the BSF supports a cookie custom feature based on a BSF profile obtained from a network repository function (NRF).

15. The method of claim 14, further comprising:
sending the binding request including the cookie custom attribute value to the BSF when the BSF supports the cookie custom feature; and
not sending the cookie custom attribute value with the binding request when the BSF does not support the cookie custom feature.

16. The method of claim 11, further comprising
receiving a second Rx session request not including the cookie custom attribute value;
looking up a primary key value from a secondary table using identifying information from the second Rx session request as a secondary key; and
looking up a second N7 session corresponding to the second Rx session request in the primary table using the primary key value.

17. The method of claim 16, further comprising
maintaining a plurality of secondary tables for looking up the primary key value, the plurality of secondary tables using different potential identifying information elements from Rx session requests as secondary keys; and
determining which secondary table from the plurality of secondary tables to use based on which information is included in the second Rx session request.

18. The method of claim 17, further comprising:
determining whether every BSF instance in a network including the PCF supports a cookie custom feature based on BSF profiles obtained from a network repository function (NRF).

19. The method of claim 18, further comprising:
maintaining the plurality of secondary tables when not every BSF instance in the network supports the cookie custom feature; and
not maintaining the plurality of secondary tables when every BSF instance in the network supports the cookie custom feature.

20. The method of claim 11, wherein:
the first Rx session request includes an initial authorization authentication request (AAR-I) message; and
the response message includes an application authentication answer (AAA) message.
